(19) United States
(12) Patent Application Publication
(10) Pub. No.: US 2016/0259857 A1
(43) Pub. Date: Sep. 8, 2016

(54) USER RECOMMENDATION USING A MULTI-VIEW DEEP LEARNING FRAMEWORK

(71) Applicant: Microsoft Technology Licensing, LLC, Redmond, WA (US)

(72) Inventors: Kuansan Wang, Bellevue, WA (US); Yang Song, Kirkland, WA (US); Ali M. Elkahky, New York, NY (US)

(73) Assignee: Microsoft Technology Licensing, LLC

(21) Appl. No.: 14/641,211

(22) Filed: Mar. 6, 2015

(51) Int. Cl. G06F 17/30; H04L 29/08

(52) U.S. Cl. CPC G06F 17/30867; H04L 67/22; G06F 17/3053; G06F 17/30876

(57) ABSTRACT

This disclosure describes systems and method for implementing a multi-view deep learning framework to map users and items to a latent space and determine similarities between users and preferred items. The multi-view deep learning framework can extract features from a domain space based at least in part on having an adequate interaction history to learn relevant user behavior patterns. The deep learning framework may leverage the learned user behavior patterns across multiple domain spaces to provide useful recommendations related to different domain spaces, including domain spaces of which a user has had little or no previous interaction. Example domain spaces include, but are not limited to, search engines, computing device applications, games, informational services, movie services, music services, and reading services.

### BACKGROUND

A common challenge among recommendation systems involves providing recommendations at an early stage of a user's interaction with a new service. Recent online services rely heavily on automated personalization to recommend relevant content items to a large number of users. A common approach is collaborative filtering, which involves predicting relevant content through a user's previous history of interaction with a web site. However, collaborative filtering requires a considerable amount of interaction history to reliably provide high quality recommendations. Unfortunately, when a user joins a new service, data upon which to base such a recommendation is extremely sparse and in some cases, non-existent. Another common approach is content-based recommendations, which uses features that correspond to items and/or users to recommend relevant content. In practice, however, content-based recommendations often fall short in effectively handling recommendations for new users, since user level features are generally more difficult to acquire and are often gleaned from limited information in a new user profile.

As a result, systems are often inadequately prepared to promptly accommodate an influx of new users visiting online services for the first time.

### SUMMARY

This disclosure describes systems and method for implementing a multi-view deep learning framework to map users and items to a latent space to determine similarities between users and preferred items. The multi-view deep learning framework can extract features from a domain space having an adequate interaction history to learn relevant user behavior patterns. The deep learning framework may leverage the learned user behavior patterns to provide useful recommendations related to a different domain space. Example domain spaces include, but are not limited to, search engines, computing device applications, games, informational services, movie services, television and/or programming services, music services, and reading services.

This Summary is provided to introduce a selection of concepts in a simplified form that are further described below in the Detailed Description. This Summary is not intended to identify key features of the claimed subject matter, nor is it intended to be used as an aid in determining the scope of the subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF DRAWINGS

The detailed description is described with reference to the accompanying figures. In the figures, the left-most digit(s) of the reference number identifies the figure in which the reference number first appears. The same reference numbers in different figures indicate similar or identical items.

FIG. 1 is block diagram depicting an example environment for implementing the multi-view deep learning framework.

FIG. 2 is a block diagram depicting aspects of example computing devices to execute the multi-view deep learning framework.

FIG. 3 is a block diagram depicting an example environment executing the multi-view Deep Neural Network (MV-DNN) process.

FIG. 4 is a block diagram depicting an example flow of determining recommendations associated with the auxiliary view of a viewing pair.

FIG. 5 is a block diagram depicting an example flow of determining the convergence of an error rate associated with an embedded pivot view.

### DETAILED DESCRIPTION

Examples described herein provide constructs of a multi-view Deep Neural Network (MV-DNN) that provides recommendations of relevant content to a user of a new service. The MV-DNN may be implemented using specialized programming and/or hardware programmed with specific instructions to implement the specified functions. For example, the MV-DNN may have different execution models as is the case for graphics processing units (GPUs) and computer processing units (CPUs).

Systems associated with a domain space often provide personalized recommendations to users by gleaning relevant data from user profiles and historical user interactions with the domain space. In instances where the level of interaction is limited-or non-existent as is the case with new users—these systems are often unable to provide relevant personalized recommendations. To address this problem, the MV-DNN can define and implement a deep learning framework that determines user behavior patterns across multiple domain spaces. The system can subsequently leverage the learned behavioral patterns to provide the user with personalized recommendations that are relevant to a new domain space where the user has a minimal history of interaction.

The methods and systems described within this disclosure can be implemented to keep users engaged within a digital eco-system, thus improving user experience, as well as reducing network bandwidth and improving processor efficiencies. These advantages can be realized by providing relevant content to a user without requiring the user to navigate to the same content. In other words, the methods and systems described herein perform acts that eliminate user search interactions steps that would normally be required to locate the same content. Moreover, as further discussed herein, reducing the dimensionality of feature vectors within a semantic space improves processing efficiencies in determining similarities, e.g., between views.

In various examples, the MV-DNN system performs this objective by extracting features from multiple domain spaces that represent both the users themselves and the items that the users interact with. By combining user features and item features from multiple domain spaces, the MV-DNN system can address data sparsity problems that often arise when a user joins a new domain space and has no history of interaction.

The term “domain space,” as described herein, is used to describe different applications and services that provide a user experience. For example a domain space can include, but is not limited to, search engines, computing device applications, games, informational services, movie services, television and programming services, music services, and reading services. Moreover, informational services can include, but are not limited to news article websites, blogs, and editorials.

In some embodiments, the multiple domain spaces can belong to a common digital ecosystem. In other embodiments, the multiple domain spaces may belong to different digital ecosystems. The term “digital ecosystem,” as described herein, is used to describe a suite of applications and services—otherwise defined as domain spaces in this disclosure—that operate on a common computing platform. For example, the Microsoft™ digital eco-system includes applications and services that operate on a common Microsoft operating system platform. These applications and services include, but are not limited to, the Bing™ Search Engine, the X-Box™ Entertainment System and applications and services running a Windows™ Operating System.

In various examples, a user may provide log-in credentials to a single domain space associated with a digital ecosystem. By example only, the log-in credentials can be associated with a search engine. In some embodiments, the user can join a new domain space. As described earlier, the new domain space can include, but is not limited to, computing device applications, games, informational services, movie services, television and programming services, music services, and reading services. In response to the user joining the new domain space, the MV-DNN method can extract and process features dimensions associated with previous interactions with the search engine, and provide relevant recommendations to the user relating to the newly joined domain space.

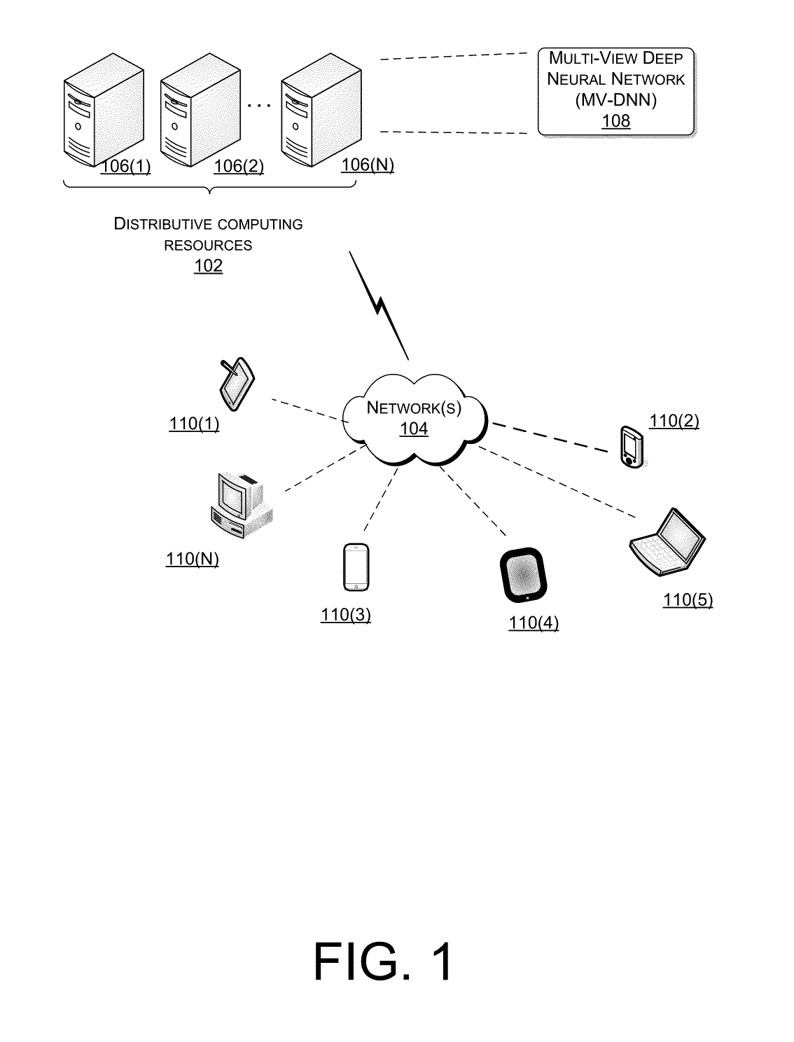

FIG. 1 is a block diagram depicting an example environment in which the multi-view deep neural network (MV-DNN) described herein may operate. In some examples, the various devices and/or components of environment include distributed computing resources 102 that can communicate with one another and with external devices via one or more networks.

For example, network(s) 104 can include public networks such as the Internet, private networks such as an institutional and/or personal intranet, or some combination of private and public networks. Network(s) 104 can also include any type of wired and/or wireless network, including but not limited to local area network (LANs), wide area networks (WANs), satellite networks, cable networks, Wi-Fi networks, WiMax networks, mobile communications networks (e.g., 3G, 4G, and so forth) or any combination thereof. Network(s) 104 can utilize communications protocols, including packet-based and/or datagram-based protocols such as internet protocol (IP), transmission control protocol (TCP), user datagram protocol (UDP), or other types of protocols. Moreover, network(s) 104 can also include a number of devices that facilitate network communications and/or form a hardware basis for the networks, such as switches, routers, gateways, access points, firewalls, base stations, repeaters, backbone devices, and the like.

In some examples, network(s) 104 can further include devices that enable connection to a wireless network, such as a wireless access point (WAP). Example examples support connectivity through WAPs that send and receive data over various electromagnetic frequencies (e.g., radio frequencies), including WAPs that support Institute of Electrical and Electronics Engineers (IEEE) 802.11 standards (e.g., 802.11g, 802.11n, and so forth), and other standards.

In various examples, distributed computing resources 102 include devices 106 (e.g., 106(1)-106(N)). Examples of support scenarios where device(s) 106 can include one or more computing devices that operate in a cluster or other grouped configuration to share resources, balance load, increase performance, provide fail-over support or redundancy, or for other purposes.

Device(s) 106, may comprise, and/or may interface with, the MV-DNN system 108. In various examples, the MV-DNN system 108 can define and implement a deep learning framework that determines user behavior patterns across multiple domain spaces.

In various examples, the MV-DNN system 108 can map user features into a pivot view and item features into one or more auxiliary views. In one embodiment, the pivot view can be defined by extracting feature representations from a search engine domain space. Particularly, a user's browsing and search histories can provide an accurate model of a user's behavior. In other embodiments, the user features can be determined by extracting feature representations from other domain spaces.

The MV-DNN system 108 can subsequently leverage the learned behavioral patterns from the user features incorporated within the pivot view domain space, and provide a user with personalized recommendations that are relevant to item features that are incorporated in an auxiliary view domain space of which the user has a minimal history of interaction. In some embodiments, an auxiliary view can correspond to a domain space other than the pivot view where user interaction is minimal or non-existent. The MV-DNN system 108 can implement a process of determining feature vectors that reflect the user features of the pivot view and the item features of an auxiliary view. The MV-DNN system 108 can leverage semantic feature mapping to combine both feature vectors into a shared semantic space. In various examples, the MV-DNN system 108 can subsequently provide recommendations that are relevant to another auxiliary view, or the same auxiliary view, by drawing on the similarities determined between the feature vectors of the pivot view and the auxiliary view in the shared semantic space.

Device(s) 106 can belong to a variety of categories or classes of devices such as traditional server-type devices, desktop computer-type devices, mobile-type devices, special purpose-type devices, embedded-type devices, and/or wearable-type devices. Thus, device(s) 106 can include a diverse variety of device types and are not limited to a particular type of device.

For example, desktop computer-type devices can represent, but are not limited to, desktop computers, server computers, web-server computers and personal computers. Mobile-type devices can represent mobile computers, laptop computers, tablet computers, automotive computers, personal data assistances (PDAs), or telecommunication devices. Embedded-type devices can include integrated components for inclusion in a computing device, or implanted computing devices. Special purpose-type devices can include thin clients, terminals, game consoles, gaming devices, work stations, media players, personal video recorders (PVRs), set-top boxes, cameras, appliances and network enabled televisions.

In various examples, device(s) 106 can include one or more interfaces to enable communications between the device(s) 106 and other networked devices, such as client device(s) 110 (e.g., 110(1)-110(N)). Client device(s) 110 can belong to a variety of categories or classes of devices, which can be the same as or different from computing device(s) 106, such as client-type devices, desktop computer-type devices, mobile-type devices, special purpose-type devices, embedded-type devices, and/or wearable-type devices. Thus, although illustrated as mobile computing devices, which may have less computing resources than device(s) 106, client computing device(s) 110 can include a diverse variety of device types and are not limited to any particular type of device. Client computing device(s) 110 can include, but are not limited to, personal data assistants (PDAs) 110(1), mobile phone tablet hybrid 110(2), mobile phone 110(3), tablet computer 110(4), laptop computers 110(5), other mobile computers, wearable computers, implanted computing devices, desktop computers, personal computers 110(N), automotive computers, network-enabled televisions, thin clients, terminals, game consoles, gaming devices, work stations, media players, personal video recorders (PVRs), set-top boxes, cameras, integrated components for inclusion in a computing device, appliances, or any other sort of computing device configured to receive user input.

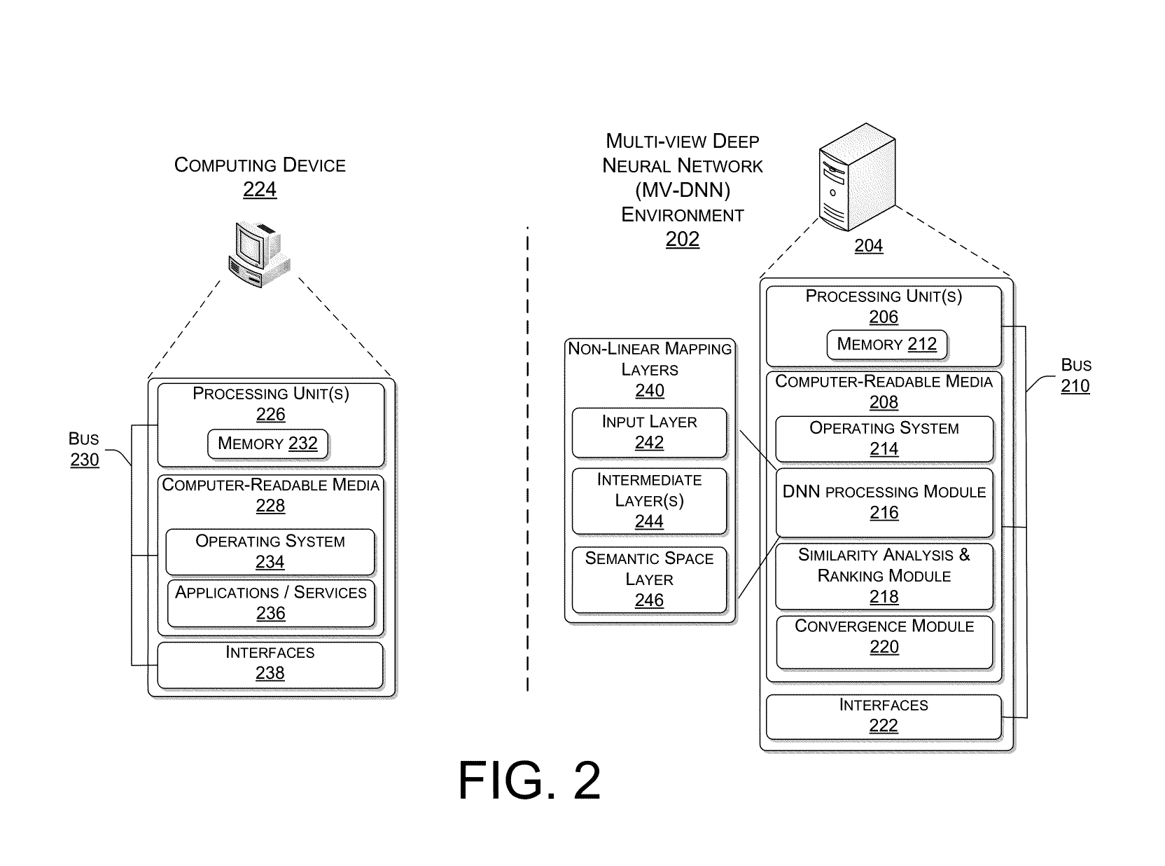

FIG. 2 illustrates an example MV-DNN environment 202 in which the multi-view deep neural network (MV-DNN) described herein may operate. In some examples, the MV-DNN environment 202 may comprise one or more computing device(s) 204 configured to execute the MV-DNN. In various examples, the one or more computing device(s) 204 can correspond to one of the devices illustrated in FIG. 1 (e.g., 106(1)-106(N)).

Computing device(s) 204 can include any computing device having one or more processing unit(s) 206 operably connected to computer-readable media 208 such as via a bus 210, which in some instances can include one or more of a system bus, a data bus, an address bus, a PCI bus, a Mini-PCI bus, and any variety of local, peripheral, and/or independent buses. The processing unit(s) 206 can also include separate memories such as memory 212 on board a CPU-type processor, a GPU-type processor, an FPGA-type accelerator, a DSP-type accelerator, and/or another accelerator. Executable instructions stored on computer-readable media 208 can include, for example, an operating system 214, a MV-DNN processing module 216, similarity analysis & ranking module 218, and a convergence module 220.

Alternatively, or in addition, the functionality described herein can be performed, at least in part, by one or more hardware logic components such as accelerators. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. For example, an accelerator can represent a hybrid device, such as one from ZYLEX or ALTERA that includes a CPU course embedded in an FPGA fabric.

Computer-readable media 208 can also store instructions executable by external processing units such as by an external CPU, an external GPU, and/or executable by an external accelerator, such as an FPGA type accelerator, a DSP type accelerator, or any other internal or external accelerator. In various examples at least one CPU, GPU, and/or accelerator is incorporated in computing device(s) 204, while in some examples one or more of a CPU, GPU, and/or accelerator is external to computing device(s) 204.

Computing device(s) 204 can also include one or more interfaces 222 to enable communications between the computing device(s) 204 and other networked devices, such as client device(s) 224. In various examples, the one or more computing device(s) 224 can correspond to one of the devices illustrated FIG. 1 (e.g., 110(a)-(110(N)). The interfaces 222 can include one or more network interface controllers (NICs), I/O interfaces, or other types of transceiver devices to send and receive communications over a network.

Client device(s) 224 can correspond to client device(s) 110(1)-110(N). Client device(s) 224 can have one or more processing units 226 operably connected to computer-readable media 228 such as via a bus 230, which in some instances can include one or more of a system bus, a data bus, an address bus, a PCI bus, a Mini-PCI bus, and any variety of local, peripheral, and/or independent buses. The processing unit(s) 226 can also include separate memories such as memory 232 on board a CPU-type processor, a GPU-type processor, an FPGA-type accelerator, a DSP-type accelerator, and/or another accelerator. Executable instructions stored on computer-readable media 228 can include, for example, an operating system 234, and an applications/services module 236. For simplicity, other modules, programs, or applications that are loadable and executable by processing unit(s) 224 are omitted from the illustrated client device(s) 224.

Client device(s) 224 can also include one or more interfaces 238 to enable communications between the client device(s) 224 and other networked devices, such as computing device(s) 204. The interfaces 238 can include one or more network interface controllers (NICs), I/O interfaces, or other types of transceiver devices to send and receive communications over a network.

Computer-readable media, such as 208 and/or 228, may include computer storage media and/or communication media. Computer storage media can include volatile memory, nonvolatile memory, and/or other persistent and/or auxiliary computer storage media, removable and non-removable computer storage media implemented in any method or technology for storage of information such as computer-readable instructions, data structures, program modules, or other data. Computer-readable media 208 and/or 228 can be examples of computer storage media similar to memories 212 and/or 232. Thus, the computer-readable media 208 and/or 228 and/or memories 212 and/or 232 includes tangible and/or physical forms of media included in a device and/or hardware component that is part of a device or external to a device, including but not limited to random-access memory (RAM), static random-access memory (SRAM), dynamic random-access memory (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

In some embodiments, the MV-DNN processing module 216 can receive user credentials from a computing device(s) 224. The user credentials may correspond to a particular domain space that is associated with a digital ecosystem. For example, the user credentials can relate to a search engine. In this instance, when the MV-DNN processing module 216 receives the user credentials, the MV-DNN processing module 216 can access feature data that corresponds to the domain space.

In other embodiments, the user credentials may be associated with the digital ecosystem rather than a specific domain space. In this instance, when the MV-DNN processing module 216 receives user credentials from a computing device(s) 224, the MV-DNN processing module 216 can access feature representations that corresponds to one or more domain spaces that are associated with the user in the digital ecosystem.

The term “feature representations,” described herein, is used to describe data derived from user interaction with a particular domain space. In various examples, feature representations correspond to user interactions that reflect the user features (e.g. user behavior) of a pivot view, or the item features (e.g. content) of an auxiliary view. For example, feature representations associated with a search engine can correspond to query strings and clicked URLs submitted by the user to the search engine. These feature representations can provide a good model of user behavior. Similarly, feature representations can be associated with a news informational service, such as a news site. These feature representations can correspond to news categories and news articles selected by the user when accessing the service. These feature representations can subsequently provide a good model of items or content that interest the user. Thus, the types of feature representations collected from different domain spaces can vary based on the characteristics of individual domain spaces. Examples of domain spaces can include, but are not limited to, search engines, computing device applications, games, news informational services, movie services, television and/or programming services, music services, and reading services. Moreover, informational services can include, but are not limited to news article websites, blogs, and editorials.

In some embodiments, the MV-DNN processing module 216 can pre-process feature representations collected from a domain space using an n-gram probabilistic language model. For example, consider feature representations collected from a search engine domain space. The feature representations can include, but are not limited to query strings and clicked URLs. In response to extracting the feature representations from the search engine domain space, the MV-DNN processing module 216 can normalize, stem and split the query strings and clicked URLs into unigram features. In other embodiments, clicked URLs can be shortened to domain-level only representations. By example only, search engine feature representations can include 3-million unigram features and 500K domain features, leading to a 3.5-million dimension search engine feature vector. Domain features can include, but are not limited to, domain-level only URL representations. In other embodiments, the search engine feature vector can retain a total length that is substantially greater or lesser than a 3.5-million dimension feature vector.

In various examples, feature representations can be collected from a “news” informational service domain space. In some embodiments, the “news” domain space can include feature representations that correspond to news item clicks within a news platform. The news item clicks can be associated with a user based on log-in credentials. The log-in credentials can be associated with the news domain space, or with the digital eco-system of which the news domain space is a part.

In some embodiments, feature representations collected from the news domain space can include, but are not limited to, news titles, categories, geo-spatial features, and named entities that correspond to the news item clicks. In some embodiments, these feature representations can be processed using any one of a Natural Language (NL) Parser, a uni-gram, bi-gram or tri-gram representation. For example, the letter tri-gram representation can function effectively for short texts, such as news titles. In other embodiments, a letter tri-gram representation can be inappropriate when modeling large collections of text. In these instances, a uni-gram or a bi-gram representation can be used to pre-process news category feature representations. By allowing different feature representations to be pre-processed using different methods, short text feature representations that correspond to news titles and to named entities can be pre-processed along with longer text feature representations that correspond to news categories and geo-spatial features. In some embodiments, a portion, but not all, of feature representations can be processed using a processing method.

By example only, the MV-DNN processing module 216 can extract and pre-process feature representations from the news domain space to determine to a 100 k length feature vector. In other embodiments, the feature vector associated with the news domain space can retain a total length that is substantially greater or lesser than the 100 k feature vector.

In some embodiments, feature representations can be collected from an “applications” domain space. In various examples, the “applications” domain space can include feature representations that correspond to applications (e.g., “apps”) accessed or downloaded onto computing device(s) 224. The feature representations can be associated with a user based on log-in credentials. The log-in credentials can be associated with the applications domain space, or with the digital eco-system of which the applications domain space is a part. In some embodiments, applications domain space can include, but are not limited to, applications relating to games, business, communication, education, finance, health and fitness, entertainment, medical, lifestyle, shopping, social, sports, and travel categories. The feature representations associated with the applications domain space can be associated with a user based on log-in credentials. The log-in credentials can be associated with the applications domain space, or with the digital eco-system of which the applications domain space is part.

In various examples, feature representations extracted from the applications domain space can include, but are not limited to, application titles and categories. In some embodiments, feature representations collected from the applications domain space can include, but are not limited to, application title, subject, and category.

By example only, the MV-DNN processing module 216 can extract and pre-process feature representations from the application domain space to determine to a 50 k length feature vector. In other embodiments, the applications domain space feature vector can retain a total length that is substantially greater or lesser than the 50 k feature vector.

In yet another embodiment, feature representations can be collected from a “movie” domain space and/or a “television” domain space. In various examples, the “movie” or a “television” domain space can include feature representations that correspond to a movie and/or television viewing history. The feature representations can be associated with a user based on log-in credentials. The log-in credentials can be associated with the movie and/or television domain space, or with the digital eco-system of which the movie and/or television domain space is a part.

In various examples, feature representations extracted from the movie and/or television domain space can include, but are not limited to, title, genre and description that correspond to the viewing history.

By example only, the MV-DNN processing module 216 can extract and pre-process feature representations from the movie and/or television domain space to determine to a 50 k length feature vector. In other embodiments, the movie and/or television domain space feature vector can retain a total length that is substantially greater or lesser than the 50 k feature vector.

In some embodiments, these feature representations for any of the example domain spaces discussed above can be processed using any one of an NL parser, uni-gram, bi-gram or tri-gram representation. In some embodiments, a portion, but not all, feature representations can be processed using a processing method. In other embodiments, the feature representations can be processed using different processing methods.

In some embodiments, the MV-DNN processing module 216 can project feature representations extracted from different domain spaces through a series non-linear mapping layers (e.g. referenced by 240, 242, 244, and 246). In various examples, the feature representations that are extracted from different domain spaces are received in an input layer 242. The input layer 242 is may be a high dimension feature space that is not conducive to efficiently run the MV-DNN system. In various examples, the high dimensionality of the input layer 242 is progressively reduced through a series of intermediate non-linear mapping layers 244 to a final semantic space layer 246. The reduced dimensional density of the semantic space layer 246. For example, consider a search engine domain space with a 3.5-million feature vector. The 3.5-million feature vector is extracted into the input layer 242, and progressively reduced through the intermediate non-linear mapping layer(s) 244 to a final feature vector length of 500 k in the semantic space layer 246. In some embodiments, a domain space can include one or more intermediate non-linear mapping layer(s) 244. An advantage of reducing the dimensionality of the feature vectors within the semantic space is to improve processing efficiencies in determining similarities between the pivot view and the auxiliary views.

In various examples, a Terms Frequency-Inverted Document Frequency (TF-IDF) process can be used within a non-linear mapping layer(s) 240 to reduce/compress feature representations associated with a domain space. The TF-IDF process can collect raw counts of words in feature representations, and identify unique terms within the feature representations. For example, consider a search query string “when is the world cup,” that is collected within a search engine domain space. The TF-IDF can identify words that have no value, such as “when is the,” and instead weigh “world cup” more heavily as a unique characteristic of the query string. In response, the TF-IDF process can be used within the non-linear mapping layer(s) 240 to retain the non-trivial feature representation that corresponds to “world cup.”

In some embodiments, a reduction in dimensional density can be performed using one or several dimensionality reduction techniques. These techniques include, but are not limited to “top-K most frequent feature,” the “K-means” clustering technique, and local sensitive hashing (LSH). The non-linear mapping layers of each individual view can use any combination of techniques to perform the dimensional and data reduction.

In various embodiments, one or more computing device(s) 204 within the MV-DNN environment 202 can include a similarity analysis & ranking module 218. The similarity analysis & ranking module 218 determines a similarity between a viewing pair of domain spaces. The term viewing pair, described herein, is used to describe the combination of a pivot view and an auxiliary view. The MV-DNN process is implemented to determine similarity between multiple viewing pairs. As described earlier, the pivot view corresponds to feature representations of a domain space (e.g. a search engine) that reflect user behavior. The auxiliary view corresponds to feature representations of a domain space (e.g. news information) that reflects items or content that interests the user. In various examples, the MV-DNN process can be implemented on multiple viewing pairs that share the same pivot view. Thus, a domain space associated with an auxiliary view that has limited or no user interaction (e.g., a cold-start) may use the pivot view to leverage another domain space associated with another auxiliary view that includes information that can be used to generate recommendations (e.g., advertisements) within the domain space associated with the auxiliary view that has limited or no user interaction. In other embodiments, the MV-DNN process can be implemented on multiple viewing pairs that have different pivot views.

In some embodiments, the MV-DNN process determines a relevance score between a viewing pair. In various examples, the pivot view can correspond to a domain space with a history of user interaction that is greater than a predetermined user interaction threshold. The predetermined user interaction threshold can be determined as a level or amount of user interaction that can adequately determine a pattern of user behavior. In other embodiments, the pivot view can correspond to a domain space that has a history of user interaction that may not satisfy the predetermined threshold but that may be more extensive relative to the user interactions of other domain spaces.

In some embodiments, the relevance score for the viewing pair is determined by a cosine similarity of the feature vectors that correspond to the pivot view and the auxiliary view in a shared semantic space. The process of determining the relevance score of a pivot view and an auxiliary view is described in more detail below.

In response to determining the relevance score of the viewing pair, the similarity analysis & ranking module 218 can rank the features of the auxiliary view relative to the pivot view features. Based at least in part on the ranking of auxiliary view feature representations, the similarity analysis & ranking module 218 can provide a user with recommendations of content that correspond to the same auxiliary view or another auxiliary view. For example, consider a user joining a new domain space. In this instance, the user has no history of user interaction with the new domain space. Subsequently, the similarity determined between the viewing pair can be used to provide the user with recommendations that are directed to the newly joined domain space.

In some embodiments, the MV-DNN process can include a convergence module 220. The convergence module 220 can iterate through multiple viewing pairs (e.g. each viewing pair comprising a pivot view and an auxiliary view). In various examples, incorporating multiple viewing pairs into a shared semantic space allows the MV-DNN system to converge to an optimal embedding of a pivot view that corresponds to all auxiliary views. The convergence of an optimal pivot view can be quantified by an error rate that reflects a rate of change of error associated with the determined similarity between the pivot view and the auxiliary view of a viewing pair. In some embodiments, the error rate is determined as the rate of change of a mean reciprocal rank (MRR). The MRR is determined as the inverse of the rank of the correct feature of the auxiliary view among other features of the auxiliary view. In various examples, if the determined error rate is less than a predetermined error rate threshold, the convergence of an optimal pivot view has occurred. In this instance, the MV-DNN system no longer requires the incorporation of additional viewing pairs to optimize the MV-DNN process. Alternatively, if the determined error rate is greater than the predetermined error rate threshold, the MV-DNN system can include additional viewing pairs so as to tend towards convergence.

In various examples, the pivot view and the one or more auxiliary views can include feature representations that are extracted from a common set of users. In other embodiments, the pivot view and the one or more auxiliary views can include feature representations from a plurality of different users. For example, the MV-DNN system can incorporate multiple viewing pairs that include independent sets of user features and item features.

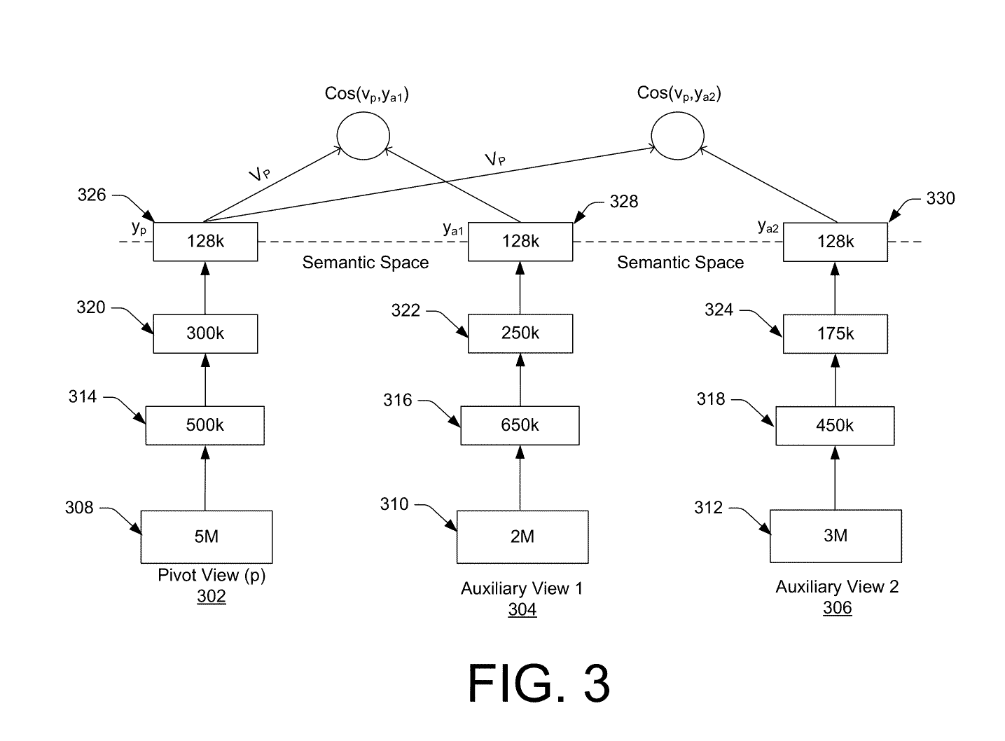

FIG. 3 illustrates a non-limiting example environment executing the MV-DNN process. The typical environment includes one pivot view 302, and one or more auxiliary views 304, 306. Each view 302, 304, 306 is associated with a different domain space. For example, the pivot view 302 can correspond to a domain space that reflects user behavior, such as a search engine. The auxiliary views 304, 306 can correspond to domain spaces that reflect items and content that interests the user, such as a news domain space or an applications domain space. In other embodiments, example pivot view and auxiliary view domain spaces can include, but are not limited to, search engines, computing device applications, games, news informational services, movie services, television or programming services, music services, and reading services.

In some embodiments, the MV-DNN process involves extracting and pre-processing feature representations from domain spaces that correspond to the pivot view 302 and auxiliary view 304, 306 domain spaces. The feature representations from each domain space can be extracted and pre-processed in an input non-linear mapping layer (e.g., referenced by 308, 310, 312) that corresponds to the pivot view 302 and auxiliary views 304, 306, respectively. For example, FIG. 3 depicts the pivot view input layer 308 as having a 5-million length feature vector. Similarly, the two auxiliary views 304, 306, can have 2-million and 3-million length feature vectors in their respective input layers 310, 312.

In some embodiments, each of the pivot view 302 and the auxiliary views 304, 306 can further comprise of a plurality of intermediate non-linear mapping layers (e.g., as referenced by 314, 316, 318, 320, 322, and 324). For example, the pivot view 302 may comprise of two non-linear mapping layers 314, 320, while the auxiliary views 304, 306, can also comprise of two non-linear mapping layers 316, 322, and 318, 324, respectively. In various examples, the pivot view 302 and the auxiliary views 304, 306 have a dissimilar number of non-linear mapping layers. In other embodiments, a number of the non-linear mapping layers associated with the views can be more or less than the two non-linear mapping layers illustrated in FIG. 3.

In some embodiments, the non-linear mapping layers (e.g., as referenced by 314, 316, 318, 320, 322, and 324) associated with the pivot view 302 and the auxiliary views 304, 306 can progressively reduce the dimensional density of (e.g., 308, 310, 312) feature vectors in the input non-linear mapping layer (e.g., referenced by 308, 310, 312) to a predetermined dimensional density in a shared semantic space (e.g., as referenced by 326, 328, and 330). The reduction in dimensional density can be performed by a number of techniques that include, but are not limited to, “top-K most frequent feature,” the “K-means” clustering technique, and local sensitive hashing (LSH). As illustrated in FIG. 3, the non-linear mapping layers (e.g., as referenced by 314, 316, 318, 320, 322, and 324) can reduce the dimensional density of the input layers (e.g., 308, 310, 312) at varying rates. For example, the feature vector length associated with the pivot view 302 was progressively reduced from 5 million to 500 k, then to 300 k, and then to 128 k. The feature vector length associated with auxiliary view 304 was reduced from 2 million to 650 k, then to 250 k, and then to −128 k.

As illustrated in FIG. 3, in the shared semantic space (e.g., as referenced by 326, 328, and 330), the feature vector length of the pivot view 302 and the auxiliary views 304, 306 share the same dimensional density. By example only, the predetermined feature vector length associated with the shared semantic space (e.g., as referenced by 326, 328, and 330) is 128 k. In other embodiments, the predetermined feature vector length associated with the shared semantic space (e.g., as referenced by 326, 328, and 330) can be greater or lesser than a 128 k length.

In some embodiments, the MV-DNN process can select a viewing pair that comprises the pivot view 302 and one auxiliary view (e.g., 304 or 306). The MV-DNN process can determine a cosine similarity of the feature vectors in the shared semantic space that correspond to the viewing pair. In one example, the objective may be to maximize the sum similarity between the pivot view Yᵤ and all other views Y₁, . . . Yᵥ, within a shared semantic space, which may be determined as follows:

$$p = {arg}_{{W}_{u} , {W}_{1} , …} {max}_{… {W}_{v}} {\sum }_{j = 1}^{N} \frac{{e}^{{α}_{a} cos ( {Y}_{u} , {Y}_{a , i} )}}{{Σ}_{{X}^{′} ∈ {R}^{{d}_{a}}} {e}^{α cos ( {Y}_{u} , {f}_{a} , {X}^{′} , {W}_{a} )}}$$

Note that other variables denoted in the above equation represent the following features: wᵤ=final user weight matrix; w_{I} {W_{I1} . . . W_{IN}}= final set of item view weight matrices; N=number of viewing pairs; M=number of training iterations.

In various examples, in response to determining the cosine similarity of the feature vectors within the shared semantic space, the MV-DNN process can determine a relevance score or a mean reciprocal rank (MRR) that ranks the features associated with the auxiliary view 304 or 306 relative to the features associated with the pivot view 302. In various examples, the MRR computes the inverse of the rank of the correct feature among other features. The MV-DNN process can subsequently provide a user with recommendations that correspond to the features of the auxiliary view 304 or 306 based at least in part on the determined MRR. In some embodiments, the MV-DNN process can be repeated for multiple viewing pairs that share a same pivot view. In other embodiments, the MV-DNN process can be repeated for multiple viewing pairs that have different pivot views. In various examples, the similarity determined between the viewing pair, or the multiple viewing pairs, can be used to provide a user with recommendations that are directed to another newly joined domain space, for which the user has no history of interaction.

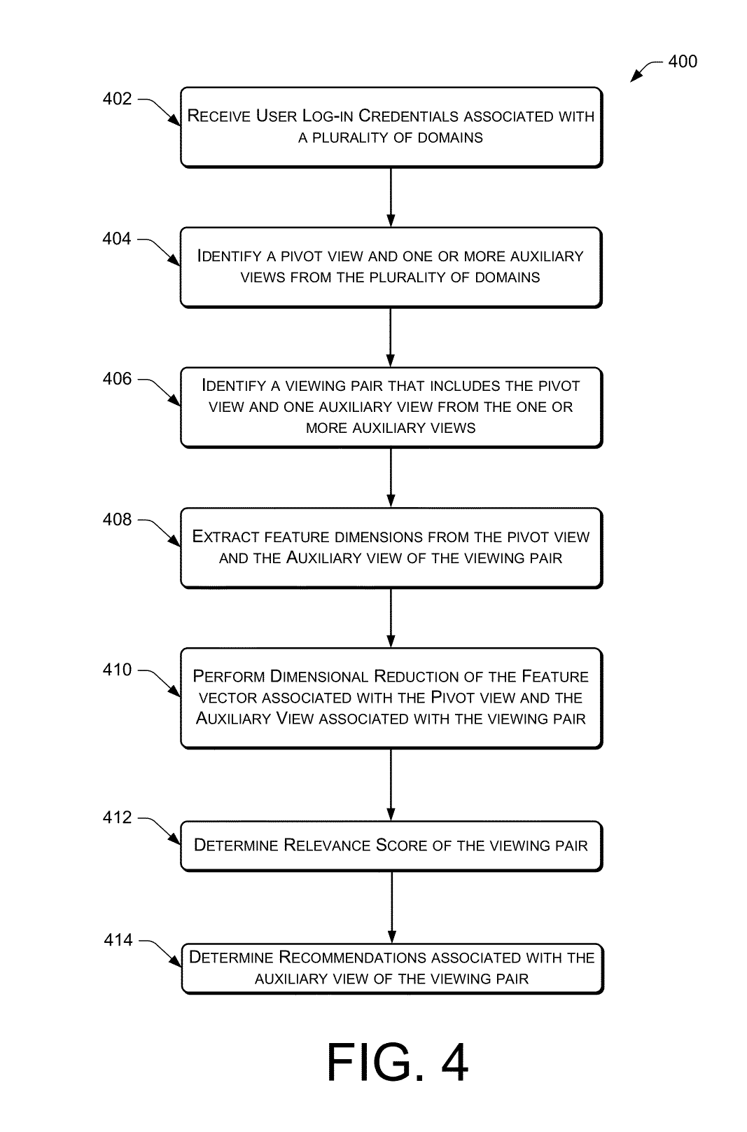

FIG. 4 illustrates an example flow of determining recommendations associated with the auxiliary view of a viewing pair. The example flow is performed using a multi-view Deep Neural Network (MV-DNN) system that is executed on one or more computing device(s) 204 in the MV-DNN environment 202. At step 402, the MV-DNN system may receive user log-in credentials associated with a single domain space that is part of a digital eco-system. In other embodiments, the log-in credentials can correspond to the digital eco-system of which the particular domain space is part. Example domain spaces include, but are not limited to, search engines, computing device applications, games, informational services, movie services, television and programming services, music services, and reading services.

At step 404, the MV-DNN system can identify a pivot view and one or more auxiliary views from the domain spaces. In some embodiments, the pivot view can correspond to a domain space that includes some history of user interaction, such as a search engine. The one or more auxiliary views correspond to domain spaces other than the pivot view. In some embodiments, the one or more auxiliary views can correspond to a new domain space that the user has joined. In these instances, the user may have had little or no interaction with the new domain space.

At step 406, the MV-DNN system can identify a viewing pair that includes the pivot view and one auxiliary view from the one or more auxiliary views. In some embodiments, the one auxiliary view may include a domain space that includes information that can address a cold-start program. The cold-start program involves providing recommendations to a domain space where the user may have little or no interaction. The recommendations can include, but are not limited to, advertisements, content items, subscriptions, or goods and services.

At step 408, the MV-DNN system can extract and pre-process feature dimensions from the pivot view and the auxiliary view of the viewing pair. The extracted feature dimensions can be selectively pre-processed using a Natural Language (NL) parser, uni-gram, bi-gram, or tri-gram representation. In various examples, the extracted and pre-processed feature representations from the pivot view is used to determine a high dimensional length feature vector. Similarly, the extracted and pre-processed feature representations from the auxiliary view of the viewing pair are used to determine another high dimensional length feature vector. In some embodiments, the feature vector lengths that correspond to the pivot view and the auxiliary view of the viewing pair have the same length. In other embodiments, the feature vector lengths that correspond to the pivot view and the auxiliary view of the viewing pair have different lengths.

At step 410, the MV-DNN system performs dimensional reduction of the feature vector associated with the pivot view and the auxiliary view of the viewing pair. In some embodiments, the non-linear mapping layers are used to progressively reduce the dimensional density of the pivot view and auxiliary view feature vectors to a predetermined dimensional density in a shared semantic space. The reduction in dimensional density can be performed using a TF-IDF process, the top-K most frequent feature, the K-means clustering technique and local sensitive hashing. The dimensional reduction of feature vectors associated with the pivot view and the auxiliary view can be performed through one or more non-linear mapping layers.

At step 412, the MV-DNN system can determine a relevance score of the viewing pair. The relevance score may be determined by the cosine similarity of the pivot view and the auxiliary view feature vectors in the shared semantic space.

At step 414, the MV-DNN system can determine a mean reciprocal rank (MRR) that ranks the features associated with the auxiliary view of the viewing pair relative to the features associated with the pivot view. In some embodiments, the MV-DNN process can subsequently provide a user with recommendations that correspond to the features of the auxiliary view based at least in part on the determined MRR. . In various examples, the similarity determined between the viewing pair, or the multiple viewing pairs, can be used to provide a user with recommendations that are directed to another newly joined domain space, for which the user has no history of interaction.

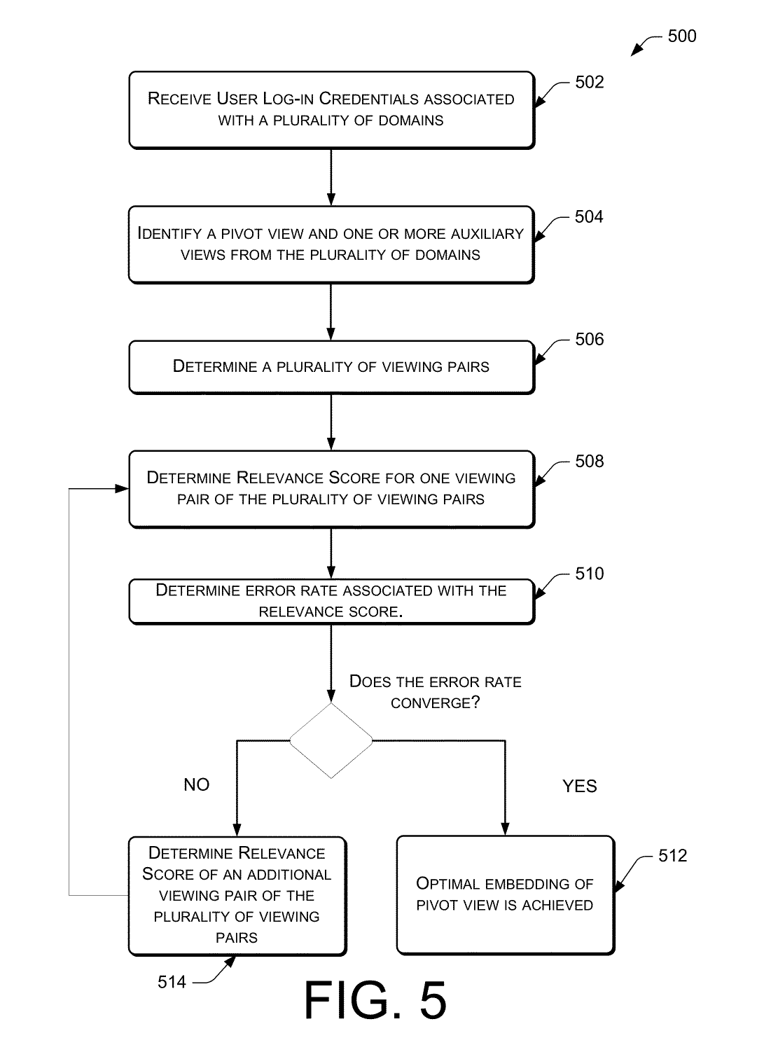

FIG. 5 illustrates an example flow of determining a convergence of the MV-DNN to an optimal embedding of a pivot view. The convergence of the MV-DNN is based on the likelihood of a user electing the recommendations proposed by the MV-DNN system. In other words, an error rate is calculated based on a user electing to either view or click on an item that has been recommended by the MV-DNN system. In instances where the user elects to repeatedly view or click on recommendations proposed by the MV-DNN system, the error rate associated with the recommendations subsequently decreases reflecting an overall convergence of the MV-DNN system to an optimal embedding of the pivot view. The convergence of an optimal pivot view can be quantified by an error rate that reflects a rate of change of error associated with the determined similarity between the pivot view and the auxiliary view of a viewing pair. The example flow is performed using the MV-DNN system that is executed on one or more computing device(s) 204 in the MV-DNN environment 202. At Step 502, the MV-DNN system receives user log-in credentials associated with a single domain space that is part of a digital eco-system. In other embodiments, the log-in credentials can correspond to the digital eco-system of which the particular domain space is part. Example domain spaces include, but are not limited to, search engines, computing device applications, games, informational services, movie services, television or programming services, music services, and reading services.

At step 504, the MV-DNN system can identify a pivot view and one or more auxiliary views from the domain spaces. In some embodiments, the pivot view can correspond to a domain space that includes some history of user interaction, such as a search engine. The one or more auxiliary views correspond to domain spaces other than the pivot view. In some embodiments, the one or more auxiliary views can correspond to a new domain space that the user has joined. In these instances, the user may have had little or no interaction with the new domain space.

At step 506, the MV-DNN system can identify a plurality of viewing pairs. Each viewing pair can include a pivot view and an auxiliary view. In some embodiments, the one auxiliary view may include a new domain space, which the user may have had little or no interaction. In various examples, the plurality of viewing pairs share a common pivot view and different auxiliary views. In other examples, the plurality of viewing pairs is comprised of different pivot views and different auxiliary views.

At step 508, the MV-DNN system can determine a relevance score for one viewing pair of the plurality of viewing pairs. The relevance score is determined based on the method steps, as described herein, e.g., in steps 408 through to 412.

At step 510, the MV-DNN system determines an error rate associated with the pivot view and the auxiliary view of the viewing pair. In various examples, the error rate is determined as the rate of change of the Mean Reciprocal Rank (MRR). The MRR is determined as the inverse of the rank of the correct feature of the auxiliary view among other features of the auxiliary view.

At step 512, if the error rate associated with the viewing pair is less than a predetermined error-rate threshold, the convergence of an optimal pivot view has occurred. In this instance, the MV-DNN system no longer requires the incorporation of additional viewing pairs to optimize the MV-DNN process.

At step 514, if the error rate associated with the viewing pair is greater than a predetermined error-rate threshold, the MV-DNN system has not converged onto an optimal embedding of a pivot view and the MV-DNN system can include additional viewing pairs so as to tend towards convergence. Subsequently, additional viewing pairs are added to the MV-DNN system, and in response, a relevance score for the additional viewing pair is determined, and the process is repeated from step 508 onwards.

### EXAMPLE CLAUSES

Example A, a method comprising: receiving user log-in credentials that correspond to a first domain space of a plurality of domain spaces; identifying a second domain space of the plurality of domain spaces; identifying a third domain space of the plurality of domain spaces; extracting, by one or more processors, a first set of feature representations from the second domain space; extracting, by one or more processors, a second set of feature representations from the third domain space; determining a similarity between the second domain space and the third domain space based at least in part on the first set of feature representations and the second set of feature representations; and providing a recommendation within the first domain space based at least in part on the similarity.

Example B, the method of Example A, wherein the first set of feature representations comprises a first feature vector length and the second set of feature representations comprises a second feature vector length, and further comprising: determining a first semantic vector that corresponds to the second domain space based at least in part on the first feature vector length; determining a second semantic vector that corresponds to the third domain space based at least in part on the second feature vector length; and wherein determining the similarity further comprises, determining a cosine similarity between the first semantic vector and the second semantic vector.

Example C, the method of Example A or Example B, further comprising ranking the second set of feature representations of the third domain space relative to the first set of feature representations of the second domain space based at least in part on the similarity.

Example D, the method of any one of Example A through Example C, wherein the second domain space corresponds to a domain space having a history of user interaction greater than a user interaction threshold, the user interaction threshold being a predetermined amount of user interaction within an individual domain space; and wherein the first set of feature representations that correspond to the second domain space reflect user features.

Example E, the method of any one of Example A through Example D, wherein the plurality of domain spaces are associated with a same digital eco-system and wherein each domain space corresponds to one of a search engine, computing device applications, games, news services, movie services, television and/or programming services, music services, or reading services.

Example F, the method of any one of Example A through Example E, wherein the first domain space corresponds to a domain space having a history of user interaction that is less than a user interaction threshold, the user interaction threshold being a predetermined amount of user interaction within an individual domain space.

Example G, the method of any one of Example A through Example F, further comprising pre-processing a portion of extracted feature representations that correspond to the second domain space and the third domain space using at least one of a Natural Language (NL) parser, a unigram representation, a bi-gram representation or a tri-gram representation.

Example H, the method of any one of Example A through Example G, wherein the first set of feature representations comprises a first feature vector length and the second set of feature representations comprises a second feature vector length; and wherein the first feature vector length and the second feature vector length are different in size.

Example I, the method of Example B, wherein the determining the first semantic vector and the second semantic vector further comprises reducing the first feature vector length and the second feature vector length to a same predetermined feature vector length.

Example J, the method of Example I, wherein the reducing progressively occurs within a plurality of non-linear mapping layers associated with the respective second domain space and the third domain space; and wherein the reducing is performed using at least one of a Terms Frequency-Inverted Document Frequency (TF-IDF) technique, a top-K most frequent feature dimensionality reduction technique, a K-means clustering technique, or a local sensitive hashing technique.

While Example A through Example J are described above with respect to a method, it is understood in the context of this document that the content of Example A through Example J may also be implemented via a system, a device, and/or computer storage media.

Example K, a system comprising: one or more processors; a computer readable medium coupled to the one or more processors, including one or more modules that are executable by the one or more processors to: receive user log-in credentials that correspond to a first domain space of a plurality of domain spaces; identify a second domain space of the plurality of domain spaces; extract from the second domain space, a first set of feature representations having a first feature vector length; identify at least one additional domain space other than the first domain space or the second domain space; extract from the at least one additional domain space, a second set of feature representations having a second feature vector length; determine at least one viewing pair that corresponds to the second domain space and the at least one additional domain space; determine a similarity that corresponds to the at least one viewing pair based at least in part on the first feature vector length and the second feature vector length; and determine a ranking of the second set of feature representations that correspond to the at least one additional domain space relative to the second domain space.

Example L, the system of Example K, wherein the one or more modules are further executable by the one or more processors to provide, within the first domain space, one or more recommendations based at least in part on the ranking of the second set of feature representations.

Example M, the system of Example K or Example L, wherein the one or more modules are further executable by the one or more processors to pre-process a portion, but not all, of the extracted first or second sets of feature representations that correspond to the second domain space or the at least one additional domain space using at least one of a Natural Language (NL) parser, unigram, bi-gram or tri-gram representation.

Example N, the system of any one of Example K through Example M, wherein each of the first domain space, the second domain space and the at least one additional domain space is associated with a digital eco-system, wherein the one or more modules are further executable by the one or more processors to identify the second domain space and the at least one additional domain space based at least in part on the user log-in credentials.

Example O, the system of any one of Example K through Example N, wherein the one or more modules are further executable by the one or more processors to progressively reduce the first feature vector length and the second feature vector length to respective semantic feature vectors having a same predetermined feature vector length.

Example P, the system of Example 0, wherein the reducing occurs within one or more non-linear mapping layers associated with the respective second domain space and the at least one additional domain space.

While Example K through Example P are described above with respect to a system, it is understood in the context of this document that the content of Example K through Example P may also be implemented via a method, a device, and/or computer storage media.

Example Q, a computer storage medium having computer-executable instructions thereon, that upon execution, configure a device to perform operations comprising: identifying a first domain space of a plurality of domain spaces; identifying a second domain space other than the first domain space; determining a first viewing pair comprising the first domain space and the second domain space; ranking feature representations of the second domain space relative to the first domain space based at least in part on a cosine similarity of feature vectors that correspond to the second domain space and the first domain space; determining a first convergence error rate associated with the ranking of the feature representations of the second domain space relative to the first domain space; in response to determining that the first convergence error rate is greater than a predetermined error-rate threshold, identifying a third domain space from the plurality of domain spaces, the predetermined error-rate threshold corresponding to an upper limit of a convergence error rate that indicates convergence; determining a second viewing pair comprising the first domain space and the third domain space; ranking feature representations of the third domain space relative to the first domain space based at least in part on a cosine similarity of feature vectors that correspond to the third domain space and the first domain space; and determining a second convergence error rate associated with the ranking of the feature representations of the third domain space relative to the first domain space.

Example R, the computer storage medium of Example Q, wherein the operations further comprise, in response to determining that the second convergence error rate is greater than the predetermined error-rate threshold, identifying a fourth domain space, and determining an additional convergence error rate for an additional viewing pair comprising the first domain space and the fourth domain space.

Example S, the computer storage medium of Example Q or Example R, wherein the first convergence error rate comprises a rate of change of a mean reciprocal rank (MRR), the MRR being determined as an inverse rank of a correct feature representation of the second domain space among other feature representations of the second domain space.

Example T, the computer storage medium of Example S, wherein the operations further comprise: providing a recommendation that is associated with the first domain space based at least in part on the ranking the feature representations of the second domain space relative to the first domain space; and wherein the correct feature representation of the second domain space is determined by an indication that a user has viewed or clicked on the recommendation.

While Example Q through Example T are described above with respect to a computer storage media, it is understood in the context of this document that the content of Example Q through Example T may also be implemented via a method, a device, and/or a system.

### CONCLUSION

Although the techniques have been described in language specific to structural features and/or methodological acts, it is to be understood that the appended claims are not necessarily limited to the features or acts described. Rather, the features and acts are described as example implementations of such techniques.

The operations of the example processes are illustrated in individual blocks and summarized with reference to those blocks. The processes are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as FPGAs, DSPs, or other types of accelerators.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

What is claimed is:

1. A method comprising:
receiving user log-in credentials that correspond to a first domain space of a plurality of domain spaces;
identifying a second domain space of the plurality of domain spaces;
identifying a third domain space of the plurality of domain spaces;
extracting, by one or more processors, a first set of feature representations from the second domain space;
extracting, by one or more processors, a second set of feature representations from the third domain space;
determining a similarity between the second domain space and the third domain space based at least in part on the first set of feature representations and the second set of feature representations; and
providing a recommendation within the first domain space based at least in part on the similarity.

2. The method as recited in claim 1, wherein the first set of feature representations comprises a first feature vector length and the second set of feature representations comprises a second feature vector length, and further comprising:
determining a first semantic vector that corresponds to the second domain space based at least in part on the first feature vector length;
determining a second semantic vector that corresponds to the third domain space based at least in part on the second feature vector length; and
wherein determining the similarity further comprises determining a cosine similarity between the first semantic vector and the second semantic vector.

3. The method as recited in claim 1, further comprising ranking the second set of feature representations of the third domain space relative to the first set of feature representations of the second domain space based at least in part on the similarity.

4. The method as recited in claim 1, wherein the second domain space corresponds to a domain space having a history of user interaction greater than a user interaction threshold, the user interaction threshold being a predetermined amount of user interaction within an individual domain space; and
wherein the first set of feature representations that correspond to the second domain space reflect user features.

5. The method as recited in claim 1, wherein the plurality of domain spaces are associated with a same digital eco-system and wherein each domain space corresponds to one of a search engine, computing device applications, games, news services, movie services, television and/or programming services, music services, or reading services.

6. The method as recited in claim 1, wherein the first domain space corresponds to a domain space having a history of user interaction that is less than a user interaction threshold, the user interaction threshold being a predetermined amount of user interaction within an individual domain space.

7. The method as recited in claim 1, further comprising pre-processing a portion of extracted feature representations that correspond to the second domain space and the third domain space using at least one of a Natural Language (NL) parser, a unigram representation, a bi-gram representation or a tri-gram representation.

8. The method as recited in claim 1, wherein the first set of feature representations comprises a first feature vector length and the second set of feature representations comprises a second feature vector length; and
wherein the first feature vector length and the second feature vector length are different in size.

9. The method as recited in claim 2, wherein the determining the first semantic vector and the second semantic vector further comprises reducing the first feature vector length and the second feature vector length to a same predetermined feature vector length.

10. The method as recited in claim 9, wherein the reducing progressively occurs within a plurality of non-linear mapping layers associated with the respective second domain space and the third domain space; and
wherein the reducing is performed using at least one of a Terms Frequency-Inverted Document Frequency (TF-IDF) technique, a top-K most frequent feature dimensionality reduction technique, a K-means clustering technique, or a local sensitive hashing technique.

11. A system comprising:
one or more processors;
a computer readable medium coupled to the one or more processors, including one or more modules that are executable by the one or more processors to:
receive user log-in credentials that correspond to a first domain space of a plurality of domain spaces;
identify a second domain space of the plurality of domain spaces;
extract, from the second domain space, a first set of feature representations having a first feature vector length;
identify at least one additional domain space other than the first domain space or the second domain space;
extract, from the at least one additional domain space, a second set of feature representations having a second feature vector length;
determine at least one viewing pair that corresponds to the second domain space and the at least one additional domain space;
determine a similarity that corresponds to the at least one viewing pair based at least in part on the first feature vector length and the second feature vector length; and
determine a ranking of the second set of feature representations that correspond to the at least one additional domain space relative to the second domain space.

12. The system as recited in claim 11, wherein the one or more modules are further executable by the one or more processors to provide, within the first domain space, one or more recommendations based at least in part on the ranking of the second set of feature representations.

13. The system as recited in claim 11, wherein the one or more modules are further executable by the one or more processors to pre-process a portion, but not all, of the extracted first or second sets of feature representations that correspond to the second domain space or the at least one additional domain space using at least one of a Natural Language (NL) parser, unigram, bi-gram or tri-gram representation.

14. The system as recited in claim 11, wherein each of the first domain space, the second domain space and the at least one additional domain space is associated with a digital eco-system, wherein the one or more modules are further executable by the one or more processors to identify the second domain space and the at least one additional domain space based at least in part on the user log-in credentials.

15. The system as recited in claim 11, wherein the one or more modules are further executable by the one or more processors to progressively reduce the first feature vector length and the second feature vector length to respective semantic feature vectors having a same predetermined feature vector length.

16. The system as recited in claim 15, wherein the reducing occurs within one or more non-linear mapping layers associated with the respective second domain space and the at least one additional domain space.

17. A computer storage medium having computer-executable instructions thereon, that upon execution, configure a device to perform operations comprising:
identifying a first domain space of a plurality of domain spaces;
identifying a second domain space other than the first domain space;
determining a first viewing pair comprising the first domain space and the second domain space;
ranking feature representations of the second domain space relative to the first domain space based at least in part on a cosine similarity of feature vectors that correspond to the second domain space and the first domain space;
determining a first convergence error rate associated with the ranking of the feature representations of the second domain space relative to the first domain space;
in response to determining that the first convergence error rate is greater than a predetermined error-rate threshold, identifying a third domain space from the plurality of domain spaces, the predetermined error-rate threshold corresponding to an upper limit of a convergence error rate that indicates convergence;
determining a second viewing pair comprising the first domain space and the third domain space;
ranking feature representations of the third domain space relative to the first domain space based at least in part on a cosine similarity of feature vectors that correspond to the third domain space and the first domain space; and
determining a second convergence error rate associated with the ranking of the feature representations of the third domain space relative to the first domain space.

18. The computer storage medium as claim 17 recites, wherein the operations further comprise, in response to determining that the second convergence error rate is greater than the predetermined error-rate threshold, identifying a fourth domain space, and determining an additional convergence error rate for an additional viewing pair comprising the first domain space and the fourth domain space.

19. The computer storage medium as claim 17 recites, wherein the first convergence error rate comprises a rate of change of a mean reciprocal rank (MRR), the MRR being determined as an inverse rank of a correct feature representation of the second domain space among other feature representations of the second domain space.

20. The computer storage medium as claim 19 recites, wherein the operations further comprise:
providing a recommendation that is associated with the first domain space based at least in part on the ranking the feature representations of the second domain space relative to the first domain space; and
wherein the correct feature representation of the second domain space is determined by an indication that a user has viewed or clicked on the recommendation.
